(19) United States
(12) Patent Application Publication
(10) Pub. No.: US 2004/0185795 A1
(43) Pub. Date: Sep. 23, 2004

(54) Electronically tunable RF Front End Module

(76) Inventors: Khosro Shamsaifar, Ellicott City, MD (US); Om Gupta, Dayton, MD (US)

Correspondence Address: James S. Finn, 8650 Southwestern Blvd. #2825, Dallas, TX, 75206-2688, US

(21) Appl. No.: 10/748,709

(22) Filed: Dec. 30, 2003

Related U.S. Application Data
(60) Provisional application No. 60/445,347, filed on Feb. 5, 2003.

(51) Int. Cl. H04B 1/46; H04B 1/44

(52) U.S. Cl. 455/83; 455/552.1; 455/82

(57) ABSTRACT

An electronically tunable RF Front End Module, comprising a first tunable bandpass filter, said first tunable bandpass filter capable of being tuned to receive a plurality of distinct frequency bands, a first lowpass filter capable of transmitting predetermined frequency bands, a first switch in communication with said first lowpass filter and said first tunable bandpass filter for switching between said first tunable bandpass filter and said first low pass filter to enable switching between transmitting and reception of RF signals, a second tunable bandpass filter, said second tunable bandpass filter capable of being tuned to receive a plurality of distinct frequency bands, a second lowpass filter capable of transmitting predetermined frequency bands, a second switch in communication with said second lowpass filter and said second tunable bandpass filter for switching between said second tunable bandpass filter and said second low pass filter to enable switching between transmitting and reception of RF signals, and an antenna in communication with a third switch, said third switch enabling switching between said first and said second switch. More specifically, first tunable bandpass filter that is capable of being tuned to receive a plurality of distinct frequency bands can be tuned to receive frequencies in the DCS and PCS bands. Also, the first lowpass filter capable of transmitting predetermined frequency bands, can transmit signals in the DCS and PCS frequency bands; and the second tunable bandpass filter is capable of being tuned to receive frequencies in the GSM 800 and GSM 900 bands.

### CROSS-REFERENCE TO RELATED APPLICATION

This application claims priority to U.S. Provisional Patent Application Ser. No. 60/445,347, “ELECTRONICALLY TUNABLE RF FRONT END MODULE” filed Feb. 05, 2003, by Khosro Shamsaifar et al.

### BACKGROUND OF THE INVENTION

The present invention generally relates to tunable filters, tunable dielectric capacitors, Tunable Diode varactors, and MEM Varactors utilized in a Tunable RF Front End Module..

Electrically tunable microwave filters have found wide range of applications in microwave systems. Compared to mechanically and magnetically tunable filters, electronically tunable filters have the most important advantage of fast tuning capability over wide frequency band applications. Because of this advantage, they can be used in the applications such as LMDS (local multipoint distribution service), cellular, GSM, PCS, UMTS, frequency hopping, satellite communication, and radar systems. In the electronically tunable filters, filters can be divided into two types: one is a voltage-controlled tunable dielectric capacitor based tunable filter; and the other is a semiconductor varactor based tunable filter. Compared to semiconductor varactor based tunable filters, tunable dielectric capacitor based tunable filters have the merits of lower loss, higher power-handling, and higher IP3, especially at higher frequencies (>10 GHz).

Tunable filters have been developed by the Assignee of the present invention, Paratek Microwave Corp., for microwave radio applications. They are tuned electronically using dielectric varactors. Tunable filters offer service providers flexibility and scalability never before accessible. A single tunable filter solution enables radio manufacturers to replace several fixed filters needed to cover a given frequency band. This versatility provides front end RF tunability in real time applications and decreases deployment and maintenance costs through software control and reduced component count. Also, fixed filters need to be wide band so that their count does not exceed reasonable numbers to cover the desired frequency plan. Tunable filters, however, are narrow band, and maybe tuned in the field by remote command.

Additionally, narrowband filters at the front end are appreciated from the systems point of view, because they provide better selectivity and help reduce interference from nearby transmitters. The trend towards the supply of RF modules rather than discrete components is very clear for Handset Manufacturers. Typically, the RF stage is spread over the circuit board necessitating extensive assembly by the OEM. These assembly costs combined with inventory and risks, design time and expense, are frustrating factors for the OEM. Consequently, the Handset Manufacturers are seeking greater levels of integration in the RF stage and are seeking to combine passives and ICs into a single package. In addition, the RF subsystem of a modem multi-mode, multi-band mobile phone represents perhaps the greatest complexity with an extremely high part count.

Therefore, a strong need in the industry exists for RF filters that can reduce complexity by replacing multiple filters and switch assemblies with a single tunable filter that can tune its center frequency over multiple bands. Ultimately, it is desirable for several of these tunable filters to be integrated into a larger module to produce even further reduction of size.

### SUMMARY OF THE INVENTION

The present invention provides an electronically tunable RF Front End Module, comprising a first tunable bandpass filter, said first tunable bandpass filter capable of being tuned to receive a plurality of distinct frequency bands, a first lowpass filter capable of transmitting predetermined frequency bands, a first switch in communication with said first lowpass filter and said first tunable bandpass filter for switching between said first tunable bandpass filter and said first low pass filter to enable switching between transmitting and reception of RF signals, a second tunable bandpass filter, said second tunable bandpass filter capable of being tuned to receive a plurality of distinct frequency bands, a second lowpass filter capable of transmitting predetermined frequency bands, a second switch in communication with said second lowpass filter and said second tunable bandpass filter for switching between said second tunable bandpass filter and said second low pass filter to enable switching between transmitting and reception of RF signals, and an antenna in communication with a third switch, said third switch enabling switching between said first and said second switch. More specifically, first tunable bandpass filter that is capable of being tuned to receive a plurality of distinct frequency bands can be tuned to receive frequencies in the DCS and PCS bands. Also, the first lowpass filter capable of transmitting predetermined frequency bands, can transmit signals in the DCS and PCS frequency bands; and the second tunable bandpass filter is capable of being tuned to receive frequencies in the GSM 800 and GSM 900 bands. Further, the second lowpass filter can transmit signals in the GSM 800 and GSM 900 frequency bands. The first tunable band pass filter can utilize voltage tunable dielectric capacitors to enable tuning or MEM varactors to enable tuning or semiconductor tunable varactors to enable tuning. The MEM varactors use a parallel plate varactor topology or an interdigital varactor topology. The electronically tunable RF Front End Module of claim can further include a duplexer associated with said first RF switch, said duplexer outputting an RF signal to a bandpass filter for transmitting a selected RF signal and receiving a selected RF signal from said bandpass filter. The selected transmitted RF signal and selected received RF signal can be a signal in the UMTS frequency band.

The present invention also provides an electronically tunable RF Front End Module, comprising an antenna for transmitting and receiving a plurality of RF signals, a first RF switch in communication with said antenna for switching a plurality of groups of RF signals, a second RF switch in communication with said first RF switch for switching between transmit and receive signals, a tunable band pass filter associated with said second RF switch for distinguishing received selected RF signals from said plurality of received RF signals, a low pass filter associated with said second RF switch for transmitting selected RF signals from said plurality of RF signals, a third RF switch in communication with said first RF switch for switching between transmit and receive signals, a tunable band pass filter associated with said third RF switch for distinguishing received selected RF signals from said plurality of received RF signals, and a low pass filter associated with said third RF switch for transmitting selected RF signals from said plurality of RF signals Further, the tunable band pass filter associated with said second RF switch for distinguishing received selected RF signals from said plurality of received RF signals, can distinguish (i.e., tune, as used in the present invention) between frequencies in the DCS and PCS bands; and said low pass filter associated with said second RF switch for transmitting selected RF signals from said plurality of RF signals, selectively transmits signals in the DCS and PCS frequency bands; and said tunable band pass filter associated with said third RF switch for distinguishing received selected RF signals from said plurality of received RF signals, distinguishes between (i.e., tunes for) frequencies in the GSM 800 and GSM 900 bands.

The low pass filter associated with said third RF switch for transmitting selected RF signals from said plurality of RF signals, selectively transmits signals in the GSM 800 and GSM 900 frequency bands. To enable tuning, said tunable band pass filter associated with said second RF switch utilizes voltage tunable dielectric capacitors, MEM varactors or semiconductor tunable varactors. The MEM varactors can use a parallel plate varactor topology or interdigital varactor topology.

The tunable band pass filter associated with said third RF switch of the electronically tunable RF Front End Module of the present invention can utilize voltage tunable varactors, MEM tunable varactors or semiconductor tunable varactors to enable tuning. The MEM varactors can use a parallel plate varactor topology or interdigital varactor topology.

The electronically tunable RF Front End Module of the present invention can additionally include a duplexer associated with said second RF switch, said duplexer outputting an RF signal to a bandpass filter for transmitting a selected RF signal and receiving a selected RF signal from said bandpass filter. The selected transmitted RF signal and selected received RF signal can include a signal in the UMTS frequency band

The present invention also provides a method of electronically tuning an RF front end using an RF Front End Module, comprising the steps of transmitting and receiving a plurality of RF signals via an antenna, switching a plurality of RF signals by frequency bands with a first RF switch in communication with said antenna, switching between transmit and receive signals with a second RF switch in communication with said first RF switch, distinguishing received selected RF signals from said plurality of received RF signals with a tunable band pass filter associated with said second RF switch, transmitting selected RF signals from said plurality of RF signals with a low pass filter associated with said second RF switch, switching between transmit and receive signals by a third RF switch in communication with said first RF switch, distinguishing received selected RF signals from said plurality of received RF signals with a tunable band pass filter associated with said third RF switch, and transmitting selected RF signals from said plurality of RF signals with a low pass filter associated with said third RF switch. The tunable band pass filter of the present method associated with said second RF switch for distinguishing received selected RF signals from said plurality of received RF signals and distinguishes between frequencies in the DCS and PCS bands. Also, in the method of the present invention the low pass filter associated with said second RF switch for transmitting selected RF signals from said plurality of RF signals, can selectively transmit signals in the DCS and PCS frequency bands and the tunable band pass filter associated with said third RF switch for distinguishing received selected RF signals from said plurality of received RF signals can distinguish between frequencies in the GSM 800 and GSM 900 bands.

Further, the low pass filter associated with said third RF switch for transmitting selected RF signals from said plurality of RF signals, can selectively transmit signals in the GSM 800 and GSM 900 frequency bands. As above, the tunable band pass filter associated with said second RF switch can utilize voltage tunable varactors, MEM tunable varactors or semiconductor tunable varactors to enable tuning. The MEM varactors can use a parallel plate varactor topology or interdigital varactor topology.

The tunable band pass filter of the present method associated with said third RF switch can also utilize voltage tunable varactors, MEM tunable varactors or semiconductor tunable varactors to enable tuning. The MEM varactors can use a parallel plate varactor topology or interdigital varactor topology. Finally, the method of electronically tuning an RF front end using an RF Front End Module of the present invention can include the step of outputting a duplexed RF signal duplexed via a duplexer associated with said second RF switch, to a bandpass filter for transmitting a selected RF signal and receiving a selected RF signal from said bandpass filter; the selected transmitted RF signal and selected received RF signal can be a signal in the UMTS frequency band.

### BRIEF DESCRIPTION OF THE DRAWINGS

FIG. 1 is a block diagram illustrating Quad-Band RF Module;

FIG. 2 is a block diagram illustrating Quad-Band RF Module with Tunable Filters; and

FIG. 3 is a block diagram illustrating 3G/Quad-Band RF Module with Tunable Filters.

### DESCRIPTION OF THE PREFERRED EMBODIMENT

As a strong need in the industry exists for the complexity of RF filters to be reduced, the present invention's electronically tunable RF filters reduces such complexity by replacing multiple filters and switch assemblies with a single tunable filter that can tune its center frequency over multiple bands. Ultimately, several of these tunable filters can be integrated into a larger module to produce even further reduction of size.

Inherent in every tunable filter is the ability to rapidly tune the response using high-impedance control lines. Paratek, the assignee of the presented, developed and patented Parascan®, the trademarked name for a materials technology that enables these tuning properties, as well as, high Q values, low losses and extremely high IP3 characteristics, even at high frequencies. MEM based varactors can also be used for this purpose. MEM based varactors use different bias voltages to vary the electrostatic force between two parallel plates of the varactor and hence change its capacitance value. They show lower Q than dielectric varactors, and have worse power handling, but can be used successfully for some applications. Also, diode varactors could be used to make tunable filters, although with worse performance than dielectric varactors.

The present invention can include electronically tunable filters used in the RF Front End Module for Handset applications and is described herein in detail as a preferred embodiment. However, it is understood that the present invention can be beneficial in any device that can utilize an RF Front End. The preferred tuning elements are voltage-controlled tunable dielectric capacitors placed on the LTCC block. The present technology makes tunable filters very promising in the contemporary mobile communication system applications.

To meet the size requirement to provide a Tunable RF Front End Module for Handset applications, as well as RF performance such as Insertion Loss, a Low Temperature Co-fired Ceramic (LTCC) package is used as a basic structure. This is made possible using Paratek's (the assignee of the present invention) electronically tunable varactors, which are mounted on the ceramic chip to form the tunable filter with good characteristics, such as, low insertion loss, fast tuning speed, high power-handling capability, high IP3 and low cost in the microwave frequency range.

The tunable dielectric capacitor in the present invention is made from low loss tunable dielectric film. The range of Q factor of the tunable dielectric capacitor is between 50, for very high tuning material, and 300 or higher, for low tuning material. Further, the material of the present invention can be utilized at room temperature. It also decreases with increasing the frequency, but even at higher frequencies, say 30 GHz, can take values as high as 100. A wide range of capacitance of the tunable dielectric capacitors is available, from 0.1 pF to several pF. The tunable dielectric capacitor is a packaged two-port component, in which a tunable dielectric can be voltage-controlled. The tunable film is deposited on a substrate, such as MgO, LaAIO3, sapphire, AhO3 or other dielectric substrates. An applied voltage produces an electric field across the tunable dielectric, which produces an overall change in the capacitance of the tunable dielectric capacitor.

The tunable capacitors with microelectromachanical technology can also be used in the tunable filter and are part of this invention. At least two varactor topologies can be used, parallel plate and interdigital. In parallel plate structure, one of the plates is suspended at a distance from the other plate by suspension springs. This distance can vary in response to electrostatic force between two parallel plates induced by applied bias voltage. In the interdigital configuration, the effective area of the capacitor is varied by moving the fingers comprising the capacitor in and out and changing its capacitance value. MEM varactors have lower Q than their dielectric counterpart, especially at higher frequencies, and have worse power handling; however, they can be used in certain applications.

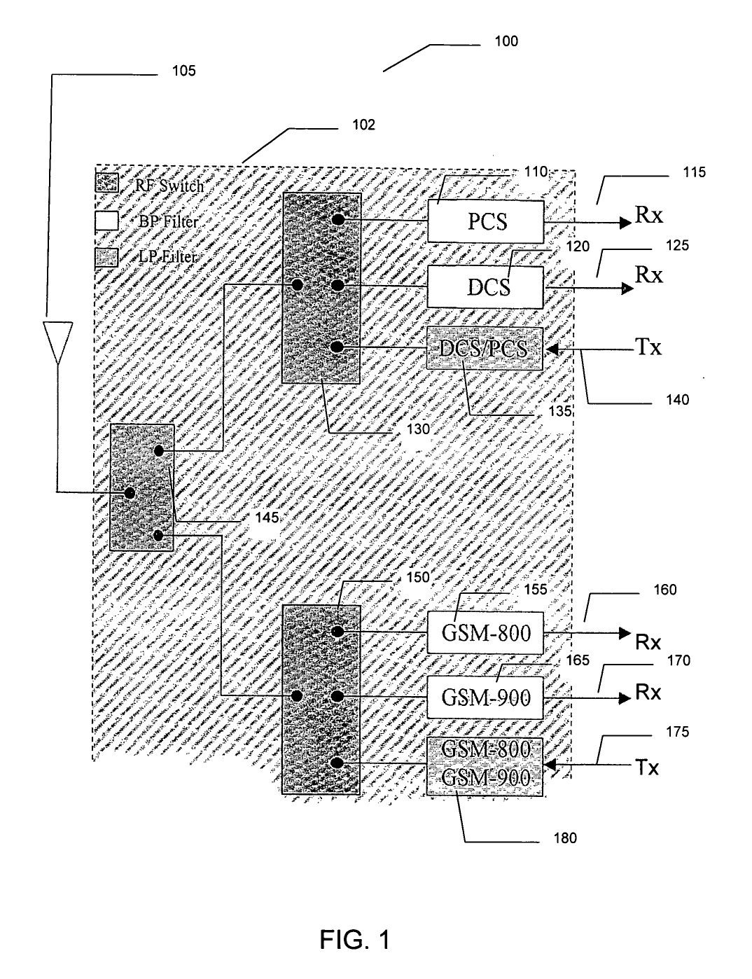

The various features of the present invention will now be described with respect to the figures. FIG. 1 illustrates the present Quad-Band RF Front end module, shown generally as 100; it covers DCS, PCS, GSM800, and GSM 900. The whole module 102 represents the LTCC package. Fixed bandpass filters 110 (PCS), 120 (DCS), 155 (GSM 800) and 165 (GSM 900) are used for the receive path 115, 125, 160 and 170 and lowpass filters 135 (DCS/PCS) and 180 (GSM 800/GSM 900) for the transmit paths. SAW filter technology facilitates this. Different filters are selected using multiple switches 130, 145 and 150. The first switch 145 can be replaced by a Diplexer with High pass and Lowpass filters, dividing the signals. Antenna 105 provides for transmission and reception of RF signals.

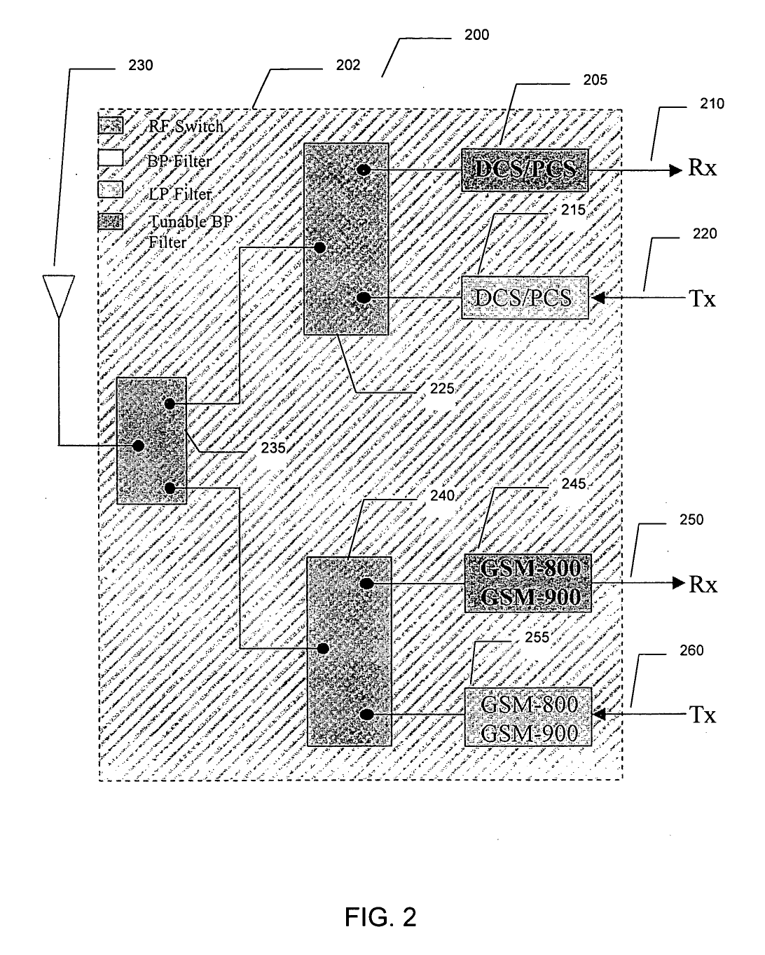

FIG. 2 shows the same application generally as 200, but with tunable filters 205, 215, 245 and 255. The whole module 202 represents the LTCC package. A single tunable bandpass filter 205 would be used to cover both DCS and PCS bands in the receive path 210. The same at low frequencies, i.e., a single bandpass filter would tune 800 and 900 MHz frequency bands 245 in the receive path 250, and of course 850 MHz. Also, low pass filters 215 and 255 provide for single filter use for the transmit side 220 for the DC/PCS frequency and transmit side 260 for GSM 800 and GSM 900. The second row of switches 225 and 240 in this case can be 2-way with the associated simplicity, versus a 3-way switch needed in FIG. 1 at 130 and 150. As in FIG. 1, the first switch 145 can be replaced by a Diplexer with High pass and Lowpass filters, dividing the signals. Again, antenna 230 provides for transmission and reception of the RF signal. Thus, with the present invention a Handset Manufacture can save two filters and use a simpler switch.

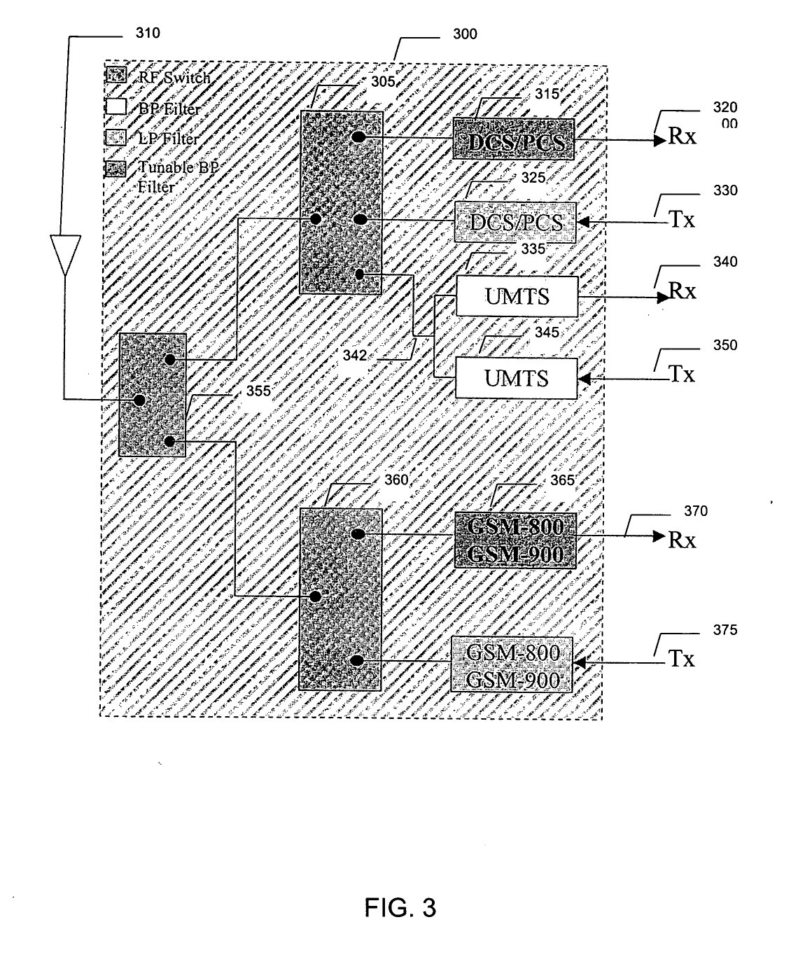

FIG. 3 is the same as FIG. 2; however, in FIG. 3 a duplexer for the UMTS band has been added. The whole module 300 represents the LTCC package. A single tunable bandpass filter 315 would be used to cover both DCS and PCS bands in the receive path 320. The same at low frequencies, i.e., a single bandpass filter would tune to 800 and 900 MHz frequency bands 365 in the receive path 370, and of course 850 MHz. Also, low pass filters 325 and 375 provide for single filter use for the transmit side 330 for the DC/PCS frequency and transmit side 370 for GSM 800 and GSM 900. The second row of switches 305 and 360 in FIG. 2 and in this case can be 2-way with the associated simplicity, versus a 3-way switch needed in FIG. 1 at 130 and 150. As in FIG. 1 and 2, the first switch 145 can be replaced by a Diplexer with High pass and Lowpass filters, dividing the signals. Antenna 310 provides for transmission and reception of the RF signal. The unique aspect of this embodiment is the duplexing 342 of the UMTS band 335 on the receive side 340 and UMTS band 345 on the transmit side 350.

The embodiment of FIG. 3 would be for 3G radios that support all the bands shown in the figure. With this architecture the UMTS needs to be a separate duplexer because in the compressed mode, DCS and UMTS signals will be received simultaneously, one for the normal operation, and one for monitoring purposes.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

What is claimed is:

1. An electronically tunable RF Front End Module, comprising:
an antenna for transmitting and receiving a plurality of RF signals;
a first RF switch in communication with said antenna for switching a plurality of groups of RF signals;
a second RF switch in communication with said first RF switch for switching between transmit and receive signals;
a tunable band pass filter associated with said second RF switch for distinguishing received selected RF signals from said plurality of received RF signals;
a low pass filter associated with said second RF switch for transmitting selected RF signals from said plurality of RF signals;
a third RF switch in communication with said first RF switch for switching between transmit and receive signals;
a tunable band pass filter associated with said third RF switch for distinguishing received selected RF signals from said plurality of received RF signals; and
a low pass filter associated with said third RF switch for transmitting selected RF signals from said plurality of RF signals.

2. The electronically tunable RF Front End Module of claim 1, wherein said tunable band pass filter associated with said second RF switch for distinguishing received selected RF signals from said plurality of received RF signals, distinguishes between frequencies in the DCS and PCS bands.

3. The electronically tunable RF Front End Module of claim 1, wherein said low pass filter associated with said second RF switch for transmitting selected RF signals from said plurality of RF signals, selectively transmits signals in the DCS and PCS frequency bands.

4. The electronically tunable RF Front End Module of claim 1, wherein said tunable band pass filter associated with said third RF switch for distinguishing received selected RF signals from said plurality of received RF signals distinguishes between frequencies in the GSM 800 and GSM 900 bands.

5. The electronically tunable RF Front End Module of claim 1, wherein said low pass filter associated with said third RF switch for transmitting selected RF signals from said plurality of RF signals, selectively transmits signals in the GSM 800 and GSM 900 frequency bands.

6. The electronically tunable RF Front End Module of claim 1, wherein said tunable band pass filter associated with said second RF switch utilizes voltage tunable dielectric capacitors to enable tuning.

7. The electronically tunable RF Front End Module of claim 1, wherein said tunable band pass filter associated with said second RF switch utilizes MEM varactors to enable tuning.

8. The electronically tunable RF Front End Module of claim 7, wherein said MEM varactors use a parallel plate varactor topology.

9. The electronically tunable RF Front End Module of claim 7, wherein said MEM varactors use an interdigital varactor topology.

10. The electronically tunable RF Front End Module of claim 1, wherein said tunable band pass filter associated with said second RF switch utilizes semiconductor tunable varactors to enable tuning.

11. The electronically tunable RF Front End Module of claim 1, wherein said tunable band pass filter associated with said third RF switch utilizes voltage tunable varactors to enable tuning.

12. The electronically tunable RF Front End Module of claim 1, wherein said tunable band pass filter associated with said third RF switch utilizes MEM tunable varactors to enable tuning.

13. The electronically tunable RF Front End Module of claim 1, wherein said tunable band pass filter associated with said third RF switch utilizes semiconductor tunable varactors to enable tuning.

14. The electronically tunable RF Front End Module of claim 1, further comprising:
a duplexer associated with said second RF switch, said duplexer outputting an RF signal to a bandpass filter for transmitting a selected RF signal and receiving a selected RF signal from said bandpass filter.

15. A method of electronically tuning an RF front end using an RF Front End Module, comprising:
transmitting and receiving a plurality of RF signals via an antenna;
switching a plurality of RF signals by frequency bands with a first RF switch in communication with said antenna;
switching between transmit and receive signals with a second RF switch in communication with said first RF switch;
distinguishing received selected RF signals from said plurality of received RF signals with a tunable band pass filter associated with said second RF switch;
transmitting selected RF signals from said plurality of RF signals with a low pass filter associated with said second RF switch;
switching between transmit and receive signals by a third RF switch in communication with said first RF switch;
distinguishing received selected RF signals from said plurality of received RF signals with a tunable band pass filter associated with said third RF switch; and
transmitting selected RF signals from said plurality of RF signals with a low pass filter associated with said third RF switch.

16. The method of electronically tuning an RF front end using an RF Front End Module of claim 15, wherein said tunable band pass filter associated with said second RF switch for distinguishing received selected RF signals from said plurality of received RF signals, distinguishes between frequencies in the DCS and PCS bands.

17. The method of electronically tuning an RF front end using an RF Front End Module of claim 15, wherein said low pass filter associated with said second RF switch for transmitting selected RF signals from said plurality of RF signals, selectively transmits signals in the DCS and PCS frequency bands.

18. The method of electronically tuning an RF front end using an RF Front End Module of claim 15, wherein said tunable band pass filter associated with said third RF switch for distinguishing received selected RF signals from said plurality of received RF signals distinguishes between frequencies in the GSM 800 and GSM 900 bands.

19. The method of electronically tuning an RF front end using an RF Front End Module of claim 15, wherein said low pass filter associated with said third RF switch for transmitting selected RF signals from said plurality of RF signals, selectively transmits signals in the GSM 800 and GSM 900 frequency bands.

20. The method of electronically tuning an RF front end using an RF Front End Module of claim 15, wherein said tunable band pass filter associated with said second RF switch utilizes voltage tunable dielectric capacitors to enable tuning.

21. The method of electronically tuning an RF front end using an RF Front End Module of claim 15, wherein said tunable band pass filter associated with said second RF switch utilizes MEM varactors to enable tuning.

22. The method of electronically tuning an RF front end using an RF Front End Module of claim 21, wherein said MEM varactors use a parallel plate varactor topology.

23. The method of electronically tuning an RF front end using an RF Front End Module of claim 21, wherein said MEM varactors use an interdigital varactor topology.

24. The method of electronically tuning an RF front end using an RF Front End Module of claim 15, wherein said tunable band pass filter associated with said second RF switch utilizes semiconductor tunable varactors to enable tuning.

25. The method of electronically tuning an RF front end using an RF Front End Module of claim 15, wherein said tunable band pass filter associated with said third RF switch utilizes voltage tunable varactors to enable tuning.

26. The method of electronically tuning an RF front end using an RF Front End Module of claim 15, wherein said tunable band pass filter associated with said third RF switch utilizes MEM tunable varactors to enable tuning.

27. The method of electronically tuning an RF front end using an RF Front End Module of claim 15, wherein said tunable band pass filter associated with said third RF switch utilizes semiconductor tunable varactors to enable tuning.

28. The method of electronically tuning an RF front end using an RF Front End Module of claim 15, further comprising:
outputting a duplexed RF signal, duplexed via a duplexer associated with said second RF switch, to a bandpass filter for transmitting a selected RF signal and receiving a selected RF signal from said bandpass filter.

29. The method of electronically tuning an RF front end using an RF Front End Module of claim 15, wherein said selected transmitted RF signal and selected received RF signal is a signal in the UMTS frequency band.

30. The electronically tunable RF Front End Module of claim 14, wherein said selected transmitted RF signal and selected received RF signal is a signal in the UMTS frequency band.

31. An electronically tunable RF Front End Module, comprising:
a first tunable bandpass filter, said first tunable bandpass filter capable of being tuned to receive a plurality of distinct frequency bands;
a first lowpass filter capable of transmitting predetermined frequency bands;
a first switch in communication with said first lowpass filter and said first tunable bandpass filter for switching between said first tunable bandpass filter and said first low pass filter to enable switching between transmitting and reception of RF signals;
a second tunable bandpass filter, said second tunable bandpass filter capable of being tuned to receive a plurality of distinct frequency bands;
a second lowpass filter capable of transmitting predetermined frequency bands;
a second switch in communication with said second lowpass filter and said second tunable bandpass filter for switching between said second tunable bandpass filter and said second low pass filter to enable switching between transmitting and reception of RF signals; and
an antenna in communication with a third switch, said third switch enabling switching between said first and said second switch.

32. The electronically tunable RF Front End Module of claim 31,
wherein said first tunable bandpass filter capable of being tuned to receive a plurality of distinct frequency bands tuned to receive frequencies in the DCS and PCS bands.

33. The electronically tunable RF Front End Module of claim 31, wherein said first lowpass filter capable of transmitting predetermined frequency bands, transmits signals in the DCS and PCS frequency bands.

34. The electronically tunable RF Front End Module of claim 31, wherein said second tunable bandpass filter capable of being tuned to receive a plurality of distinct frequency bands receives frequencies in the GSM 800 and GSM 900 bands.

35. The electronically tunable RF Front End Module of claim 31, wherein second lowpass filter capable of transmitting predetermined frequency bands transmits signals in the GSM 800 and GSM 900 frequency bands.

36. The electronically tunable RF Front End Module of claim 31, wherein said first tunable band pass filter utilizes voltage tunable dielectric capacitors to enable tuning.

37. The electronically tunable RF Front End Module of claim 31, wherein said first tunable band pass filter utilizes MEM varactors to enable tuning.

38. The electronically tunable RF Front End Module of claim 37, wherein said MEM varactors use a parallel plate varactor topology.

40. The electronically tunable RF Front End Module of claim 37, wherein said MEM varactors use an interdigital varactor topology.

41. The electronically tunable RF Front End Module of claim 31, wherein said first tunable band pass filter utilizes semiconductor tunable varactors to enable tuning.

42. The electronically tunable RF Front End Module of claim 31, wherein said second tunable band pass filter utilizes voltage tunable varactors to enable tuning.

43. The electronically tunable RF Front End Module of claim 31, wherein said second tunable band pass filter utilizes MEM tunable varactors to enable tuning.

44. The electronically tunable RF Front End Module of claim 31, wherein said second tunable band pass filter utilizes semiconductor tunable varactors to enable tuning.

45. The electronically tunable RF Front End Module of claim 31, further comprising:
a duplexer associated with said first RF switch, said duplexer outputting an RF signal to a bandpass filter for transmitting a selected RF signal and receiving a selected RF signal from said bandpass filter.

46. The electronically tunable RF Front End Module of claim 45, wherein said selected transmitted RF signal and selected received RF signal is a signal in the UMTS frequency band.
